(19) United States
(12) Patent Application Publication
(10) Pub. No.: US 2022/0023970 A1
(43) Pub. Date: Jan. 27, 2022

(54) LASER WELDING DEVICE

(71) Applicant: AISIN AW INDUSTRIES CO., LTD., Echizen-shi, Fukui (JP)

(72) Inventors: Kouji TAKEMOTO, Echizen-shi, Fukui (JP); Kazuyoshi MIYAMOTO, Echizen-shi, Fukui (JP); Tomoaki YOSHIDA, Echizen-shi, Fukui (JP); Daichi SUMIMORI, Kani-shi, Gifu (JP); Hiroshi HASEGAWA, Kani-shi, Gifu (JP)

(73) Assignee: AISIN AW INDUSTRIES CO., LTD., Echizen-shi, Fukui (JP)

(21) Appl. No.: 17/299,500

(22) PCT Filed: Dec. 4, 2019
(86) PCT No.: PCT/JP2019/047431

§ 371 Date: Jun. 3, 2021

(30) Foreign Application Priority Data
Dec. 4, 2018 (JP) 2018-227489

(51) Int. Cl. B23K 26/21; B23K 26/12; B23K 26/16

(52) U.S. Cl. CPC B23K 26/21; B23K 26/127; B23K 26/1224; B23K 26/16; B23K 26/128

(57) ABSTRACT

This laser welding device includes a tubular portion. The tubular portion includes a first tubular portion and a second tubular portion. The second tubular portion has a constant cross-sectional shape orthogonal to an irradiation direction along the irradiation direction E. The tubular portion has a predetermined length that is longer than a length of a chamber in the irradiation direction.

### TECHNICAL FIELD

The present invention relates to a laser welding device, and more particularly to a laser welding device including a chamber having a low-pressure internal space in which a workpiece is disposed and a laser beam irradiation unit that irradiates the workpiece with a laser beam to weld the workpiece.

### BACKGROUND ART

In the related art, a laser welding device is known, which includes a chamber having a low-pressure internal space in which a workpiece is disposed and a laser beam irradiation unit that irradiates the workpiece with a laser beam to weld the workpiece. For example, such a laser welding device is disclosed in Japanese Patent No. 5234471.

Japanese Patent No. 5234471 discloses a laser welding device, which includes a chamber in which a workpiece disposed inside is welded in a low vacuum atmosphere and a laser unit (laser beam irradiation unit) that irradiates the workpiece with a laser beam generated by a laser oscillator. The laser welding device of Japanese Patent No. 5234471 includes a shield gas pipe which is disposed between the laser unit and the chamber and to which a shield gas is supplied and a transmission window which is disposed on a side opposite to a laser beam irradiation direction side of the shield gas pipe.

In the laser welding device of Japanese Patent No. 5234471, the workpiece is irradiated with the laser beam from a laser unit that has passed through a space inside the shield gas pipe and a space inside the chamber. Then, in the laser welding device of Japanese Patent No. 5234471, the workpiece is melted by the laser beam with which the workpiece is irradiated, and thus, the workpiece is welded.

### CITATION LIST

### Patent Literature

[PTL 1] Japanese Patent No. 5234471

### SUMMARY OF INVENTION

### Technical Problem

Here, in the laser welding device of Japanese Patent No. 5234471, the inside of the chamber has a low vacuum atmosphere. Accordingly, metal vapor ejected from the workpiece melted by the laser beam passes through the shield gas pipe and heads toward the transmission window. In this case, in the laser welding device of Japanese Patent No. 5234471, by supplying the shield gas to the shield gas pipe, it is possible to prevent the metal vapor ejected from the workpiece from reaching the transmission window and adhering to the transmission window.

However, in the laser welding device of Japanese Patent No. 5234471, by further weakening momentum of the metal vapor ejected from the workpiece, it is desired to more reliably prevent the metal vapor ejected from the work from reaching the transmission window (laser transmission window) and adhering to the transmission window. Here, when the metal vapor adheres to the transmission window, the laser beam transmitted through the transmission window is blocked by the metal vapor adhering to the transmission window, welding of the workpiece becomes unstable, welding defects occur in the workpiece, and thus, it is necessary to clean the transmission window.

The present invention is made to solve the above problems, and one object of the present invention is to provide a laser welding device capable of preventing metal vapor from adhering to a transmission window when a workpiece is melted.

### Solution to Problem

As a result of diligent studies by the inventor of the present application in order to achieve the object, a new finding has been obtained that by enlarging a tubular portion, it is possible to further weaken a force of metal vapor ejected from a workpiece and more effectively prevent the metal vapor from adhering to the transmission window when the workpiece is melted. The laser welding device according to one aspect of the present invention utilizes this new finding to prevent the metal vapor from adhering to the laser transmission window when welding the workpiece. That is, according to an aspect of the present invention, there is provided a laser welding device including: a chamber that has a low-pressure internal space in which a workpiece is disposed; a laser beam irradiation unit that irradiates the workpiece with a laser beam to weld the workpiece; and a tubular portion through which the laser beam from the laser beam irradiation unit passes and which communicates with the chamber, in which the tubular portion includes a first tubular portion that is disposed on a side opposite to an irradiation direction side of the laser beam and has a laser transmission window through which the laser beam is transmitted and a second tubular portion which has a space through which the laser beam passes and is adjacent to the irradiation direction side of the first tubular portion, the second tubular portion has a constant cross-sectional shape orthogonal to the irradiation direction along the irradiation direction, and the tubular portion has a predetermined length longer than a length of the chamber in the irradiation direction.

In the laser welding device according to one aspect of the present invention, as described above, the tubular portion includes the first tubular portion that is disposed on the side opposite to the irradiation direction side of the laser beam and has the laser transmission window through which the laser beam is transmitted. The tubular portion includes the second tubular portion which has the space through which the laser beam passes and is adjacent to the irradiation direction side of the first tubular portion. The tubular portion has the predetermined length that is longer than the length of the chamber in the irradiation direction. Accordingly, a distance from a processing point at which the laser beam is applied to the workpiece to the laser transmission window can increase by a longer length of the second tubular portion in the irradiation direction. As a result, it is possible to prevent the metal vapor ejected from the processing point of the workpiece by the laser beam from reaching the laser transmission window, and thus, it is possible to prevent the metal vapor from adhering to the laser transmission window when the workpiece is welded. Further, the tubular portion is configured to have the predetermined length longer than the length of the chamber in the irradiation direction. Therefore, since a volume of the tubular portion is larger than that of a case where the tubular portion is smaller than the length of the chamber in the irradiation direction, it is possible to more easily diffuse the metal vapor in the tubular portion. In this respect as well, it is possible to prevent the metal vapor from adhering to the laser transmission window.

In the laser welding device according to the above one aspect, preferably, an end portion of the first tubular portion on the irradiation direction side does not protrude into the space of the second tubular portion, and is adjacent to an end portion of the second tubular portion on a side opposite to the irradiation direction side. According to this configuration, a position at which the first tubular portion communicates with the second tubular portion can be disposed on the side opposite to the irradiation direction side as compared with the case where the end portion of the first tubular portion on the irradiation direction side protrudes into the space of the second tubular portion. As a result, the metal vapor that has entered the second tubular portion can be prevented from entering the first tubular portion, and thus, it is possible to further prevent the metal vapor from adhering to the laser transmission window. Further, a shape of the first tubular portion can be prevented from being complicated as compared with the case where the end portion of the first tubular portion on the irradiation direction side protrudes into the space of the second tubular portion, and thus, it is possible to easily attach the first tubular portion to the second tubular portion.

In the laser welding device according to the above one aspect, preferably, the cross-sectional shape of the second tubular portion orthogonal to the irradiation direction is a rectangular shape. According to this configuration, compared with a case where the cross-sectional shape of the second tubular portion orthogonal to the irradiation direction is a circular shape, in the case where the cross-sectional shape is a rectangular shape having a side having the same width as a diameter of the circular shape, a cross-sectional area of the tubular portion in the direction orthogonal to the irradiation direction can increase. As a result, it is possible to easily secure the space in the second tubular portion necessary for diffusing the metal vapor ejected from the processing point of the workpiece.

In the laser welding device including the second tubular portion having the rectangular cross-sectional shape, preferably, the second tubular portion has an upper surface portion extending in the irradiation direction in a plan view, and the rectangular cross-sectional shape of the second tubular portion has a flat shape in which a length in the first direction orthogonal to the irradiation direction in an in-plane direction of the upper surface portion is longer than a length in a second direction orthogonal to the irradiation direction and the first direction. According to this configuration, by forming the flat shape having the long length in the first direction, it is possible to prevent a size of the second tubular portion from increasing in the second direction while increasing the cross-sectional area of the second tubular portion. As a result, it is possible to prevent the second tubular portion from interfering with other configurations in the second direction, and it is possible to secure the volume of the space in the second tubular portion necessary for diffusing the metal vapor ejected from the processing point of the workpiece.

In the laser welding device including the second tubular portion having the flat cross-sectional shape, preferably, the length of the second tubular portion in the first direction is longer than half a length of the chamber in the first direction. According to this configuration, the metal vapor ejected from the processing point of the workpiece to the side opposite to the irradiation direction side can be diffused in the first direction, and thus, it can make it difficult for the metal vapor to adhere to the laser transmission window.

In the laser welding device including the second tubular portion having the flat cross-sectional shape, preferably, a length of the first tubular portion in the first direction is shorter than the length of the second tubular portion in the first direction. According to this configuration, the cross-sectional area of the first tubular portion becomes smaller than the cross-sectional area of the second tubular portion, it is difficult for the metal vapor to enter the first tubular portion, and thus, it can further make it difficult for the metal vapor to adhere to the laser transmission window.

In this case, preferably, a cross-sectional shape of the first tubular portion orthogonal to the irradiation direction has a circular shape. According to this configuration, compared with a case where the cross-sectional shape of the first tubular portion is the same rectangular shape as the cross-sectional shape of the second tubular portion, the cross-sectional area of the first tubular portion decreases, and thus, it can further make it difficult for the metal vapor to enter the first tubular portion.

In the laser welding device including the second tubular portion having the flat cross-sectional shape, preferably, the laser welding device further includes a pump which exhausts air in the chamber to form a low pressure in the internal space of the chamber, in which the chamber or the second tubular portion includes an exhaust port that is connected to the pump and is disposed at a predetermined distance from an end portion of the workpiece opposite to the irradiation direction side to the side opposite to the irradiation direction side. According to this configuration, the exhaust flow in the vicinity of the processing point of the workpiece generated by the exhaust using the pump can be directed from the vicinity of the processing point of the workpiece in the direction opposite to the irradiation direction. As a result, it is possible to prevent the exhaust flow in the vicinity of the processing point of the workpiece generated by the exhaust using the pump from being directed to a direction along the surface of the workpiece, and thus, it is possible to prevent undulations (unevenness) from occurring on the surface portion of a molten metal portion at the processing point of the workpiece.

In a laser welding device including the exhaust port disposed at a predetermined distance from the workpiece, preferably, the laser welding device further includes a support portion that rotatably supports the workpiece around a rotation axis along the second direction, in which the exhaust port is provided on a side surface portion of the chamber or the second tubular portion on a rotation direction side at a processing point where the laser beam from the laser beam irradiation unit is applied to the workpiece. According to this configuration, the exhaust flow from the vicinity of the processing point of the workpiece toward the exhaust port can be made to follow the air flow in the chamber generated by the rotation of the workpiece, and thus, it is possible to prevent the air flow in the chamber generated by the rotation of the workpiece from being disturbed. As a result, it is possible to further prevent the undulations (unevenness) from occurring on the surface portion of the molten metal portion at the processing point of the workpiece.

### Advantageous Effects of Invention

According to the present invention, as described above, it is possible to prevent the metal vapor from adhering to the transmission window when the workpiece is melted.

### BRIEF DESCRIPTION OF DRAWINGS

FIG. 1 is a schematic cross-sectional view illustrating the entire laser welding device according to a first embodiment.

FIG. 2 is a schematic cross-sectional view illustrating a chamber and a tubular portion in the laser welding device according to the first embodiment.

FIG. 3 is a schematic cross-sectional view illustrating a cross-sectional shape of a second tubular portion in the laser welding device according to the first embodiment.

FIG. 4 is a cross-sectional view schematically illustrating a laser welding device used in an example.

FIG. 5 is a cross-sectional view schematically illustrating a laser welding device used in a first comparative example.

FIG. 6 is a cross-sectional view schematically illustrating a laser welding device used in a second comparative example.

FIG. 7 is a diagram illustrating a laser transmission window after a workpiece is welded by the laser welding device used in the second comparative example.

FIG. 8 is a cross-sectional view schematically illustrating a laser welding device used in a third comparative example.

FIG. 9 is a diagram illustrating a laser transmission window after a workpiece is welded by the laser welding device used in the third comparative example.

FIG. 10 is a cross-sectional view schematically illustrating a laser welding device used in a fourth comparative example.

FIG. 11 is a diagram illustrating a laser transmission window after a workpiece is welded by the laser welding device used in the fourth comparative example.

FIG. 12 is a cross-sectional view schematically illustrating a laser welding device used in a fifth comparative example.

FIG. 13 is a diagram illustrating a laser transmission window after a workpiece is welded by the laser welding device used in the fifth comparative example.

FIG. 14 is a schematic cross-sectional view illustrating a chamber and a tubular portion in a laser welding device according to a second embodiment.

### DESCRIPTION OF EMBODIMENTS

Hereinafter, embodiments of the present invention will be described.

### First Embodiment

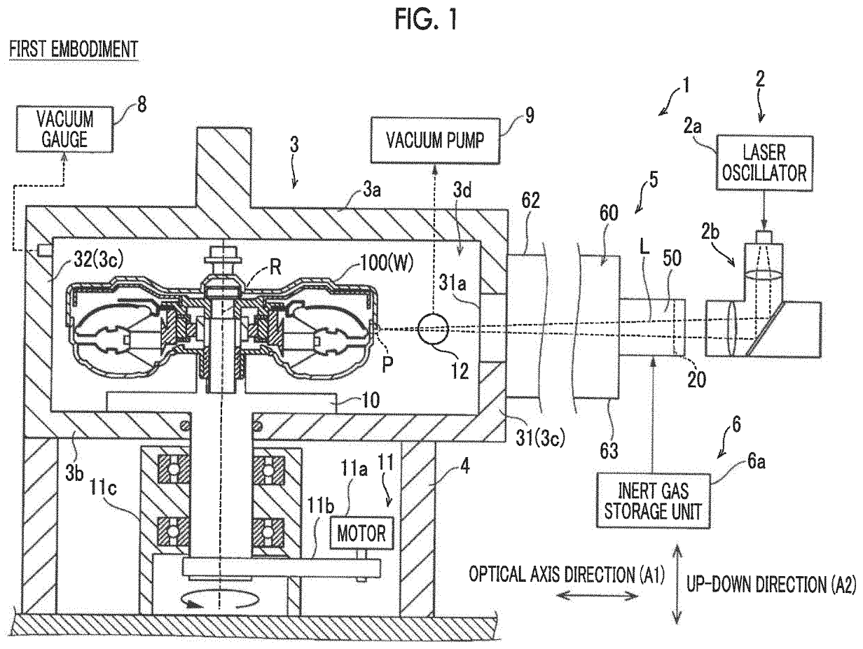

First, a configuration of a laser welding device 1 according to a first embodiment of the present invention will be described with reference to FIGS. 1 to 3.

(Laser Welding Device)

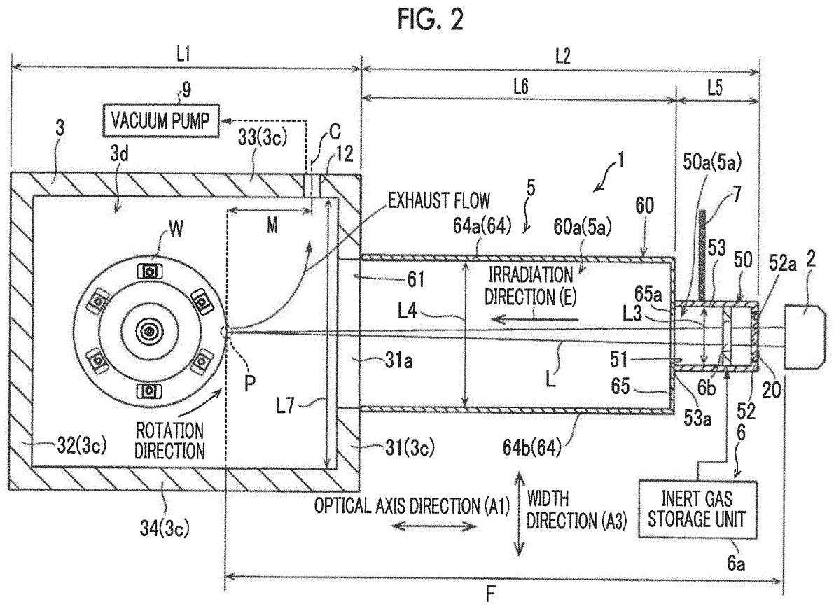

As illustrated in FIG. 1, the laser welding device 1 is configured to perform welding, by a laser beam L, on a torque converter 100 (hereinafter, workpiece W) that transmits rotational torque from an engine to a shaft of a transmission. Specifically, the laser welding device 1 includes a laser beam irradiation unit 2, a chamber 3, a leg portion 4, a tubular portion 5, an inert gas supply unit 6, a shutter 7 (refer to FIG. 2), and the like. It includes a vacuum gauge 8, a vacuum pump 9, a support portion 10, and a rotation drive mechanism 11. The vacuum pump 9 is an example of a “pump” in claims.

The laser beam irradiation unit 2 is configured to irradiate the workpiece W with the laser beam L to weld the workpiece W. Here, the laser beam irradiation unit 2 uses known laser such as a CO₂ laser, a YAG (Yttrium aluminum garnet) laser, a fiber laser, or a disk laser. Specifically, the laser beam irradiation unit 2 includes a laser oscillator 2a that generates the laser beam L and an optical system 2b that adjusts a focus of the laser beam L generated by the laser oscillator 2a. Further, the laser beam irradiation unit 2 has a long focal length (focal length F: about 900 [mm]). In the workpiece W, a point to which the laser beam L from the laser beam irradiation unit 2 is applied is defined as a processing point P.

Here, a direction in which an optical axis of the laser beam L emitted from the optical system 2b in the laser beam irradiation unit 2 extends is defined as an optical axis direction A1. Further, a direction orthogonal to the optical axis direction A1 and an up-down direction A2 is defined as a width direction A3. Further, a direction in which the laser beam L emitted from the optical system 2b in the laser beam irradiation unit 2 toward the workpiece W is defined as an irradiation direction E. The width direction A3 is an example of the “first direction” of claims. The up-down direction A2 is an example of the “second direction” of claims.

As illustrated in FIGS. 1 and 2, the chamber 3 is configured to accommodate the workpiece W therein. Specifically, the chamber 3 includes an upper wall portion 3a, a lower wall portion 3b, a side wall portion 3c provided between the upper wall portion 3a and the lower wall portion 3b, and an internal space 3d surrounded by the upper wall portion 3a, the lower wall portion 3b, and the side wall portion 3c. The side wall portion 3c has a first side wall portion 31 in which an opening 31a through which the laser beam L passes is formed, and a second side wall portion 32 facing the first side wall portion 31 in the optical axis direction A1. Further, the side wall portion 3c has a third side wall portion 33 in which an exhaust port 12 connected to the vacuum pump 9 is formed, and a fourth side wall portion 34 facing the third side wall portion 33 in the width direction A3. Here, the chamber 3 is made of a metal such as aluminum.

Further, in the chamber 3, the internal space 3d is set to a low vacuum atmosphere (about 0.1 kPa) by adjusting an air pressure of the internal space 3d using the vacuum gauge 8 and the vacuum pump 9. That is, the chamber 3 has a low-pressure internal space 3d in which the workpiece W is disposed.

The leg portion 4 extends in the up-down direction A2 and supports the chamber 3 from below. In the leg portion 4, an upper end portion is attached to a lower end portion of the lower wall portion 3b, and a lower end portion is attached to a floor.

The tubular portion 5 allows the laser beam L from the laser beam irradiation unit 2 to transmit and communicates with the chamber 3. Specifically, the tubular portion 5 includes a first tubular portion 50 that is disposed on a side opposite to the irradiation direction E side and has a laser transmission window 20 through which the laser beam L can be transmitted, and a second tubular portion 60 that has a space 60a through which the laser beam L passes and is adjacent to the irradiation direction E side of the first tubular portion 50. Here, the first tubular portion 50 has a space 50a through which the laser beam L passes. The space 50a of the first tubular portion 50 communicates with the internal space 3d of the chamber 3 via the space 60a of the second tubular portion 60. The tubular portion 5 is formed with an internal space 5a in which the space 50a of the first tubular portion 50 and the space 60a of the second tubular portion 60 are combined.

As a result, the laser beam L from the laser beam irradiation unit 2 passes through the laser transmission window 20, the space 50a of the first tubular portion 50, the space 60a of the second tubular portion 60, and the internal space 3d of the chamber 3 in this order and reaches the workpiece W.

The inert gas supply unit 6 is configured to supply an inert gas (nitrogen, argon, carbon dioxide, helium, or the like) into the tubular portion 5. Specifically, the inert gas supply unit 6 includes an inert gas storage unit 6a that stores the inert gas and a gas injection nozzle 6b that injects the inert gas supplied from the inert gas storage unit 6a into the internal space 5a of the tubular portion 5.

The shutter 7 is configured to block the internal space 5a on an exit side in the optical axis direction A1 from the laser transmission window 20. Specifically, the shutter 7 moves in the width direction A3, and thus, can switch communication or cutoff between a space from the laser transmission window 20 of the first tubular portion to the shutter 7 and the internal space 3d of the chamber 3. The shutter 7 is disposed in the first tubular portion 50.

As the vacuum gauge 8, a known vacuum gauge such as an ionization vacuum gauge is used. As the vacuum pump 9, a known vacuum pump such as a rotary type vacuum pump is used. The vacuum pump 9 is configured to exhaust air in the chamber 3 to form a low pressure of the internal space 3d of the chamber 3.

The support portion 10 is configured to rotatably support the workpiece W around a rotation axis R along the up-down direction A2. The support portion 10 is connected to the rotation drive mechanism 11. Accordingly, the support portion 10 is rotated around the rotation axis R by drive of the rotation drive mechanism 11. Further, since the workpiece W is attached to the support portion 10, the workpiece W rotates as the support portion 10 rotates around the rotation axis R.

The rotation drive mechanism 11 is configured to rotate the support portion 10 around the rotation axis R. Specifically, the rotation drive mechanism 11 includes a motor 11a, a belt 11b having one end portion hung on the motor 11a and the other end portion hung on the support portion 10, and a bearing 11c supporting the support portion 10.

(Tubular Portion)

Hereinafter, the above-mentioned tubular portion 5 will be described in more detail.

The tubular portion 5 of the present embodiment has a predetermined length L2 that is longer than a length L1 of the chamber 3 in the irradiation direction E. The predetermined length L2 of the tubular portion 5 is the sum of a length L5 of the first tubular portion 50 in the irradiation direction E and a length L6 of the second tubular portion 60 in the irradiation direction E. Further, the predetermined length L2 of the tubular portion 5 is shorter than a focal length F of the laser beam irradiation unit 2. Accordingly, the laser transmission window 20 is disposed at a position separated from the processing point P of the workpiece W by a predetermined length L2 of the tubular portion 5. Here, preferably, the predetermined length L2 of the tubular portion 5 is about 1.15 times or more the length L1 of the chamber 3 in the irradiation direction E.

<First Tubular Portion>

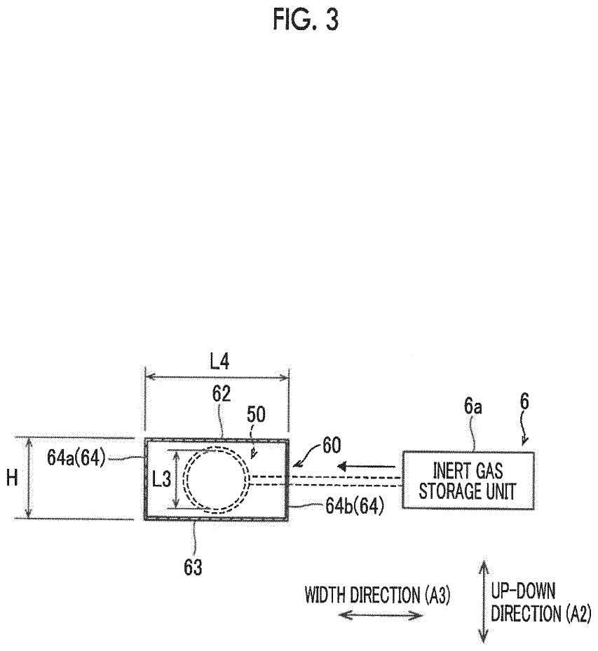

As illustrated in FIGS. 2 and 3, the first tubular portion 50 has a cylindrical shape including an opening 51 at an end portion 53a on the exit side in the optical axis direction A1. That is, a cross-sectional shape of the first tubular portion 50 orthogonal to the irradiation direction E has a circular shape. Here, the first tubular portion 50 includes an end surface portion 52 which is formed in a circular shape when viewed from the irradiation direction E and is provided on a side opposite to the irradiation direction E and a side peripheral surface portion 53 that protrudes to the irradiation direction E side from a peripheral edge portion of the end surface portion 52. The end surface portion 52 of the first tubular portion 50 has an opening 52a into which the laser transmission window 20 is fitted.

As illustrated in FIG. 2, the end portion 53a of the first tubular portion 50 on the irradiation direction E side is attached to an end portion of the second tubular portion 60 on the side opposite to the irradiation direction E side. Here, the end portion 53a of the first tubular portion 50 on the irradiation direction E side does not protrude into the space 60a of the second tubular portion 60, and is adjacent to an end portion of the second tubular portion 60 on the side opposite to the irradiation direction E side. That is, the end portion 53a on the irradiation direction E side of the side peripheral surface portion 53 of the first tubular portion 50 does not have a nozzle shape protruding into the space 60a of the second tubular portion 60.

A volume of the first tubular portion 50 is smaller than a volume of the second tubular portion 60. That is, a length L3 of the first tubular portion 50 in the width direction A3 is shorter than a length L4 of the second tubular portion 60 in the width direction A3. Further, the length L3 of the first tubular portion 50 in the width direction A3 is longer than a length of the laser transmission window 20 in the width direction A3. A length L5 of the first tubular portion 50 in the irradiation direction E is shorter than a length L6 of the second tubular portion 60 in the irradiation direction E. Further, the length L5 of the first tubular portion 50 in the irradiation direction E is longer than a length of about ⅓ of the second tubular portion 60 in the irradiation direction E.

<Second Tubular Portion>

As illustrated in FIGS. 2 and 3, the second tubular portion 60 has a square tubular shape having an opening 61 at an end portion on the irradiation direction E side. That is, a cross-sectional shape of the second tubular portion 60 orthogonal to the irradiation direction E has a rectangular shape. Further, the second tubular portion 60 has a constant cross-sectional shape along the irradiation direction E. Here, the second tubular portion 60 includes an upper surface portion 62, a lower surface portion 63, and a side surface portion 64 provided between the upper surface portion 62 and the lower surface portion 63. The side surface portion 64 of the second tubular portion 60 includes an end surface portion 65 provided on the side opposite to the irradiation direction E side, a first side surface portion 64a provided on the exhaust port 12 side in the width direction A3, and a second side surface portion 64b facing the first side surface portion 64a. The end surface portion 65 of the second tubular portion has a communication port 65a which communicates the space 50a of the first tubular portion 50 and the space 60a of the second tubular portion 60.

The second tubular portion 60 is disposed between the first tubular portion 50 and the chamber 3. That is, the end portion of the second tubular portion 60 on the irradiation direction E side is attached to the end portion of the chamber 3 opposite to the irradiation direction E side. The end portion of the second tubular portion 60 opposite to the irradiation direction E side is attached to the end portion of the first tubular portion 50 on the irradiation direction E side.

Further, as illustrated in FIG. 3, the rectangular cross-sectional shape of the second tubular portion 60 has a flat shape in which the length L4 in the width direction A3 is longer than a length H in the up-down direction A2. That is, in the second tubular portion 60, in order to prevent a volume of the second tubular portion 60 from increasing in the up-down direction A2 while securing the volume of the second tubular portion 60, the cross-sectional shape of the second tubular portion 60 orthogonal to the irradiation direction E is formed to be a flat shape among the rectangular shapes. Specifically, in the second tubular portion 60, the length L4 of each of the upper surface portion 62 and the lower surface portion 63 in the width direction A3 is longer than the length H of each of the first side surface portion 64a and the second side surface portion 64b in the up-down direction A2.

As illustrated in FIG. 2, in the second tubular portion 60, in order to prevent metal vapor ejected to the side opposite to the irradiation direction E side from adhering to the laser transmission window 20 when the laser beam L is applied to the processing point P of the workpiece W, the processing point P and the laser transmission window 20 are separated by at least the second tubular portion 60. Specifically, the length L6 of the second tubular portion 60 in the irradiation direction E is longer than about ⅘ of the length L1 of the chamber 3 in the irradiation direction E. Further, the length L6 of the second tubular portion 60 in the irradiation direction E is shorter than the length L1 of the chamber 3 in the irradiation direction E. Further, the length L4 of the second tubular portion 60 in the width direction A3 is longer than half of a length L7 of the chamber 3 in the width direction A3. Further, the length L4 of the second tubular portion 60 in the width direction A3 is shorter than the length L7 of the chamber 3 in the width direction A3.

In order to secure a volume for diffusing the ejected metal vapor, the volume of the space 60a of the second tubular portion 60 is smaller than the volume of the internal space 3d of the chamber 3, and is larger than the volume of the space 50a of the first tubular portion 50.

(Exhaust Port)

Hereinafter, the exhaust port 12 will be described in more detail.

As illustrated in FIG. 2, the exhaust port 12 of the present embodiment is connected to the vacuum pump 9 and is disposed at a predetermined distance M from an end portion (processing point P) of the workpiece W opposite to the irradiation direction E side to the side opposite to the irradiation direction E side. That is, the exhaust port 12 is disposed at a predetermined distance M from the processing point P in order to suppress the occurrence of undulations on a surface portion of a molten metal portion at the processing point P of the workpiece W. Here, the exhaust port 12 is disposed at a position where an exhaust flow in the vicinity of the processing point P of the workpiece W generated by the exhaust using the vacuum pump 9 is generated from the vicinity of the processing point P of the workpiece W to the side opposite to the irradiation direction E side.

The predetermined distance M is a distance between the processing point P of the workpiece W and a central portion C of the exhaust port 12 in the optical axis direction A1. The predetermined distance M has a length of about ⅙ or more of the length L1 of the chamber 3 in the irradiation direction E.

Further, the exhaust port 12 is disposed at a position corresponding to a rotation direction of the workpiece W so as not to disturb an air flow generated by the rotation of the workpiece W. Specifically, the exhaust port 12 is provided on a side surface portion 64 on the rotation direction side at the processing point P. Here, since the rotation direction of the workpiece W is counterclockwise, the exhaust port 12 is formed on the third side wall portion 33 as described above.

(Effect of First Embodiment)

In the first embodiment, the following effects can be obtained.

In the first embodiment, as described above, the tubular portion 5 includes the first tubular portion 50 that is disposed on the side opposite to the irradiation direction E side and has the laser transmission window 20 through which the laser beam L can be transmitted. The tubular portion 5 includes the second tubular portion 60 that has the internal space 5a through which the laser beam L passes and is adjacent to the irradiation direction E side of the first tubular portion 50. The tubular portion 5 has the predetermined length L2 that is longer than the length L1 of the chamber 3 in the irradiation direction E. Accordingly, the distance from the processing point P at which the laser beam L is applied to the workpiece W to the laser transmission window 20 can increase by the longer length L6 of the second tubular portion 60 in the irradiation direction E. As a result, it is possible to prevent the metal vapor ejected from the processing point P of the workpiece W by the laser beam L from reaching the laser transmission window 20, and thus, it is possible to prevent the metal vapor from adhering to the laser transmission window 20 when the workpiece W is welded. Further, the tubular portion 5 is configured to have the predetermined length L2 longer than the length L1 of the chamber 3 in the irradiation direction E. Therefore, since the volume of the tubular portion 5 is larger than that of a case where the tubular portion 5 is smaller than the length L1 of the chamber 3 in the irradiation direction E, it is possible to more easily diffuse the metal vapor in the tubular portion 5. In this respect as well, it is possible to prevent the metal vapor from adhering to the laser transmission window 20. Further, since the metal vapor ejected from the processing point P of the workpiece W by the laser beam L is less likely to adhere to the laser transmission window 20, it is possible to stably weld the workpiece W.

Further, in the first embodiment, as described above, the end portion 53a of the first tubular portion 50 on the irradiation direction E side does not protrude into the space 60a of the second tubular portion 60, and is adjacent to the end portion of the second tubular portion on the side opposite to the irradiation direction E side. Accordingly, the position at which the first tubular portion 50 communicates with the second tubular portion 60 can be disposed on the side opposite to the irradiation direction E as compared with the case where the end portion 53a of the first tubular portion 50 on the irradiation direction E side protrudes into the space 60a of the second tubular portion 60. As a result, the metal vapor that has entered the second tubular portion 60 can be prevented from entering the first tubular portion 50, and thus, it is possible to further prevent the metal vapor from adhering to the laser transmission window 20. Further, the shape of the first tubular portion 50 can be prevented from being complicated as compared with the case where the end portion 53a of the first tubular portion 50 on the irradiation direction E side protrudes into the space 60a of the second tubular portion 60, and thus, it is possible to easily attach the first tubular portion 50 to the second tubular portion 60.

Further, in the first embodiment, as described above, the cross-sectional shape of the second tubular portion 60 orthogonal to the irradiation direction E has a rectangular shape. Accordingly, compared with a case where the cross-sectional shape of the second tubular portion 60 orthogonal to the irradiation direction E is a circular shape, in the case where the cross-sectional shape is a rectangular shape having a side having the same width as a diameter of the circular shape, a cross-sectional area of the second tubular portion 60 in the direction orthogonal to the irradiation direction E can increase. As a result, it is possible to easily secure the space 60a in the second tubular portion 60 necessary for diffusing the metal vapor ejected from the processing point P of the workpiece W.

Further, in the first embodiment, as described above, the second tubular portion 60 has the upper surface portion 62 extending in the irradiation direction E in a plan view, and the rectangular cross-sectional shape of the second tubular portion 60 has a flat shape in which the length L4 in the width direction A3 is longer than the length H in the up-down direction A2. Accordingly, by forming the flat shape having the long length L4 in the width direction A3, it is possible to prevent a size of the second tubular portion 60 from increasing in the up-down direction A2 while increasing the cross-sectional area of the second tubular portion 60. As a result, it is possible to prevent the second tubular portion 60 from interfering with other configurations in the up-down direction A2, and it is possible to secure the volume of the space 60a in the second tubular portion 60 necessary for diffusing the metal vapor ejected from the processing point P of the workpiece W.

Further, in the first embodiment, as described above, the length L4 of the second tubular portion 60 in the width direction A3 is longer than half of the length L7 of the chamber 3 in the width direction A3. Accordingly, the metal vapor ejected from the processing point P of the workpiece W to the side opposite to the irradiation direction E can be diffused in the width direction A3, and thus, it can make it difficult for the metal vapor to adhere to the laser transmission window 20.

Further, in the first embodiment, as described above, the length L3 of the first tubular portion 50 in the width direction A3 is shorter than the length L4 of the second tubular portion 60 in the width direction A3. Accordingly, the cross-sectional area of the first tubular portion 50 becomes smaller than the cross-sectional area of the second tubular portion 60, it is difficult for the metal vapor to enter the first tubular portion 50, and thus, it can further make it difficult for the metal vapor to adhere to the laser transmission window 20.

Further, in the first embodiment, as described above, the cross-sectional shape of the first tubular portion 50 orthogonal to the irradiation direction E has a circular shape. Accordingly, compared with a case where the cross-sectional shape of the first tubular portion 50 is the same rectangular shape as the cross-sectional shape of the second tubular portion 60, the cross-sectional area of the first tubular portion 50 decreases, and thus, it can further make it difficult for the metal vapor to enter the first tubular portion 50.

Further, in the first embodiment, as described above, the chamber 3 includes the exhaust port 12 that is connected to the vacuum pump 9 and is disposed at the predetermined distance M from the end portion of the workpiece W opposite to the irradiation direction E side to the side opposite to the irradiation direction E side. Accordingly, the exhaust flow in the vicinity of the processing point P of the workpiece W generated by the exhaust using the vacuum pump 9 can be directed from the vicinity of the processing point P of the workpiece W in the direction opposite to the irradiation direction E. As a result, it is possible to prevent the exhaust flow in the vicinity of the processing point P of the workpiece W generated by the exhaust using the vacuum pump 9 from being directed to a direction along the surface of the workpiece W, and thus, it is possible to prevent the undulations (unevenness) from occurring on the surface portion of the molten metal portion at the processing point P of the workpiece W.

Further, in the first embodiment, as described above, the exhaust port 12 is provided on the third side wall portion 33 of the chamber 3. Accordingly, the exhaust flow from the vicinity of the processing point P of the workpiece W toward the exhaust port 12 can be made to follow the air flow in the chamber 3 generated by the rotation of the workpiece W, and thus, it is possible to prevent the air flow in the chamber 3 generated by the rotation of the workpiece W from being disturbed. As a result, it is possible to further prevent the undulations (unevenness) from occurring on the surface portion of the molten metal portion at the processing point P of the workpiece W.

Further, in the first embodiment, as described above, the laser beam irradiation unit 2 has the long focal length (focal length F: about 900 [mm]). Accordingly, the distance between the processing point P and the laser transmission window 20 can further increase, and thus, it is possible to further prevent the metal vapor from adhering to the laser transmission window 20.

Further, in the first embodiment, by disposing the exhaust port 12 in the vicinity of the processing point P as described above, it is possible to stably exhaust the metal vapor together with the air around the processing point P. As a result, a degree of vacuum at the processing point P can be stabilized, and thus, quality of a welded portion of the workpiece W can be improved.

(Experimental Results of Welding of Workpieces Using Laser Welding Device)

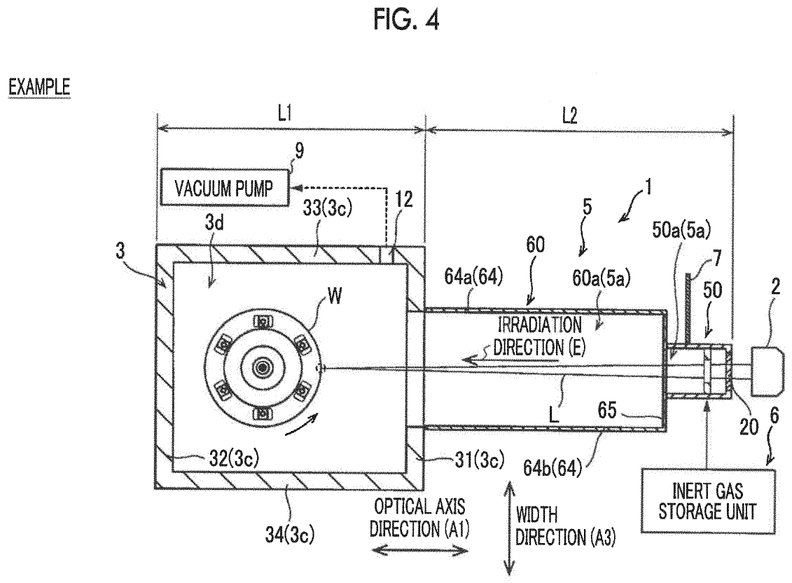

Next, with reference to FIGS. 4 to 13 and Table 1, when the workpiece W is welded using the laser welding device 1 and laser welding devices 201, 301, 401, 501, and 601 having modified configurations, an example and first to fifth comparative examples illustrating dirt of the laser transmission window 20 will be described. Table 1 is a table illustrating experimental results of the example and the first to fifth comparative examples.

TABLE 1

| | Experimental result | Remark |
|---|---|---|
| Example | No dirt | |
| First comparative | There is dirt | Dirt adhesion at |
| example | | first welding |
| Second comparative | There is dirt | Dirt adhesion at |
| example | | first welding |
| Third comparative | There is dirt | Dirt adhesion at |
| example | | first welding |
| Fourth comparative | There is dirt | Sputtering is adhered |
| example | | |
| Fifth comparative | There is dirt | Dirt adhesion at |
| example | | fifth welding |

### EXAMPLE

The example will be described with reference to FIG. and Table 1. The example is the experimental result when the workpiece W is welded by using the laser welding device 1.

As illustrated in FIG. 4, the volume of the internal space 3d of the chamber 3 is larger than the volume of the internal space 5a of the tubular portion 5. The length L1 of the chamber 3 in the irradiation direction E is shorter than the length L2 of the tubular portion 5 in the irradiation direction E.

In the example, the workpiece W (torque converter 100) was welded by the laser welding device 1 under the following conditions. The volume of the internal space 3d of the chamber 3 is 38 [L]. The volume of the internal space 5a of the tubular portion 5 is 23 [L]. The length L1 of the chamber 3 in the irradiation direction E is 510 [mm]. The length of the tubular portion 5 in the irradiation direction E is 590 [mm]. The pressure in the internal space 3d of the chamber 3 is 0.1 [kPa]. The output of the laser beam irradiation unit 2 is 4.0 [kW]. The focal length F of the laser beam irradiation unit 2 is 900 [mm]. The inert gas is nitrogen. The predetermined distance M between the processing point P and the exhaust port 12 is 90 [mm].

As illustrated in Table 1, in the experimental results of the example, dirt due to the metal vapor did not adhere to the laser transmission window 20. As a result, it can be seen that the metal vapor is effectively diffused in the tubular portion 5 by sufficiently securing the length L2 of the tubular portion 5 in the irradiation direction E.

### First Comparative Example

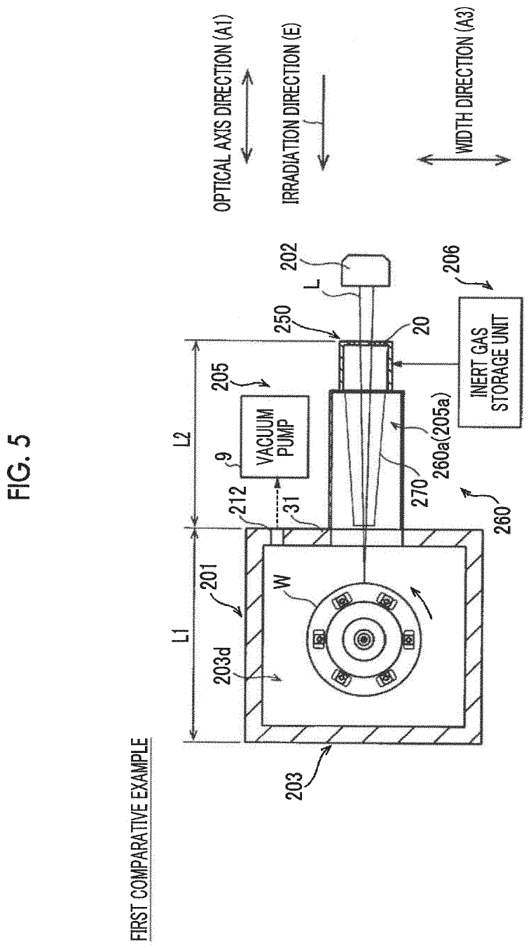

The first comparative example will be described with reference to FIG. 5 and Table 1. The first comparative example is the experimental result when the workpiece W is welded by using the laser welding device 201 having the configuration different from that of the laser welding device 1 of the example.

As illustrated in FIG. 5, a volume of an internal space 203d of a chamber 203 is larger than a volume of an internal space 205a of a tubular portion 205. A length L1 of the chamber 203 in the irradiation direction E is longer than a length L2 of the tubular portion 205 in the irradiation direction E. An exhaust port 212 is disposed on the first side wall portion 31. Further, in a space 260a of a second tubular portion 260, a tapered nozzle 270 protrudes from the end portion 53a of the first tubular portion 250 on the irradiation direction E side.

In the first comparative example, the workpiece W (torque converter 100) was welded by the laser welding device 201 under the following conditions. A volume of the internal space 203d of the chamber 203 is 12 [L]. A volume of the internal space 205a of the tubular portion 205 is 4 [L]. A pressure in the internal space 3d of the chamber 3 is 0.1 [kPa]. An output of a laser beam irradiation unit 202 is 4.0 [kW]. A focal length F of the laser beam irradiation unit 202 is 250 [mm]. An inert gas is nitrogen. A diameter of the exhaust port 212 is 25 [mm].

As illustrated in Table 1, in the experimental result of the first comparative example, after the workpiece W is welded once by the laser beam irradiation unit 202, the dirt due to metal vapor adheres to the laser transmission window 20. As a result, it can be seen that the metal vapor is not effectively diffused in the tubular portion 205 because the length L2 of the tubular portion 205 in the optical axis direction A1 is not sufficiently secured. Further, it can be seen that the tapered nozzle 270 protrudes into the space 260a of the second tubular portion 260, and thus, it is not possible to prevent the metal vapor from adhering to the laser transmission window 20.

### Second Comparative Example

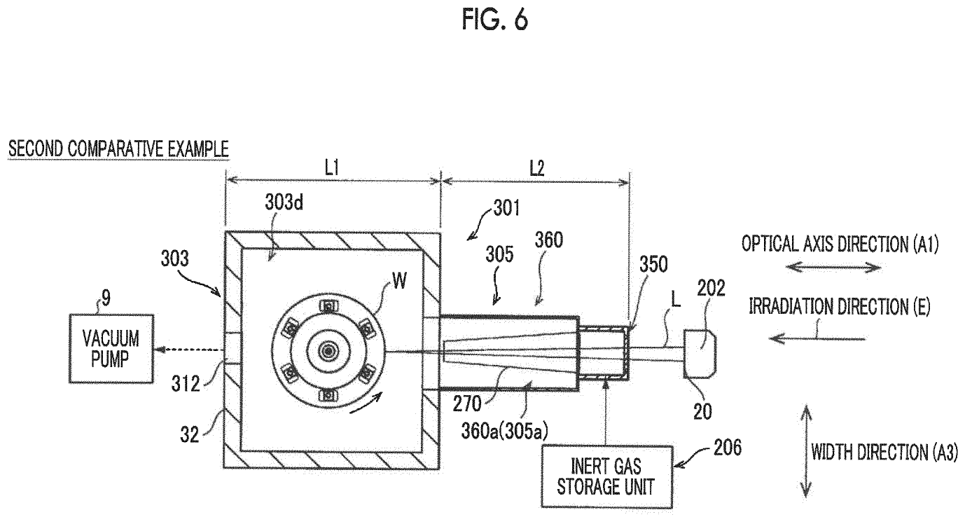

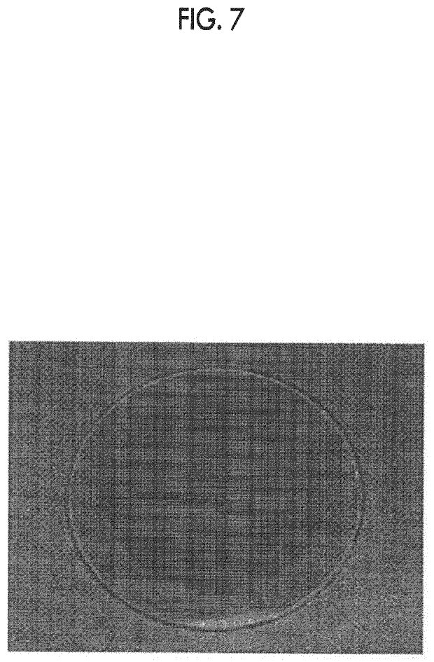

The second comparative example will be described with reference to FIGS. 6 and 7, and Table 1. The second comparative example is the experimental result when the workpiece W is welded by using the laser welding device 301 having the configuration different from that of the laser welding device 201 of the first comparative example.

As illustrated in FIG. 6, a volume of an internal space 303d of a chamber 303 is larger than a volume of an internal space 305a of a tubular portion 305. A length L1 of the chamber 3 in the irradiation direction E is longer than a length L2 of the tubular portion 5 in the irradiation direction E. An exhaust port 312 is disposed on the second side wall portion 32. Further, in a space 360a of the second tubular portion 360, a tapered nozzle 270 protrudes from an end portion of the first tubular portion 350 on the irradiation direction E side.

In the second comparative example, the workpiece W (torque converter 100) was welded by the laser welding device 301 under the following conditions. A volume of the internal space 303d of the chamber 303 is 12 [L]. A volume of the internal space 305a of the tubular portion 305 is 4 [L]. A pressure in the internal space 303d of the chamber 303 is 0.1 [kPa]. The output of the laser beam irradiation unit 202 is 4.0 [kW]. The focal length F of the laser beam irradiation unit 202 is 250 [mm]. An inert gas is nitrogen. A diameter of the exhaust port 312 is 50 [mm].

FIG. 7 illustrates a state of the laser transmission window 20 after the workpiece W is welded once by the laser beam irradiation unit 202 in the second comparative example. As illustrated in Table 1, from the experimental result of the second comparative example, the dirt due to metal vapor adheres to the laser transmission window 20. Accordingly, it can be seen that the metal vapor is not effectively diffused in the tubular portion 305 because the length L2 of the tubular portion 305 in the irradiation direction E is not sufficiently secured. Further, it can be seen that although the exhaust port 312 is large, the exhaust of the metal vapor cannot be promoted. Further, it can be seen that the tapered nozzle 270 protrudes into the space 360a of the second tubular portion 360, and thus, it is not possible to prevent the metal vapor from adhering to the laser transmission window 20.

### Third Comparative Example

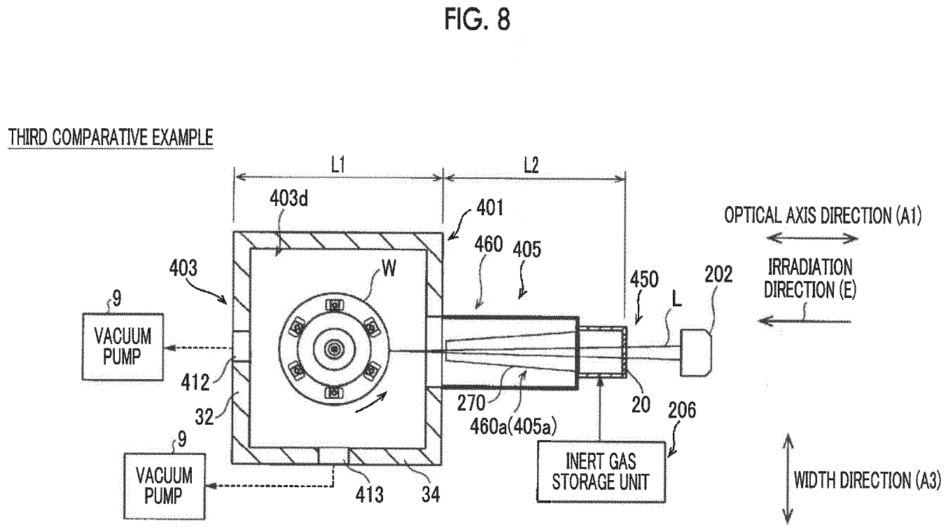

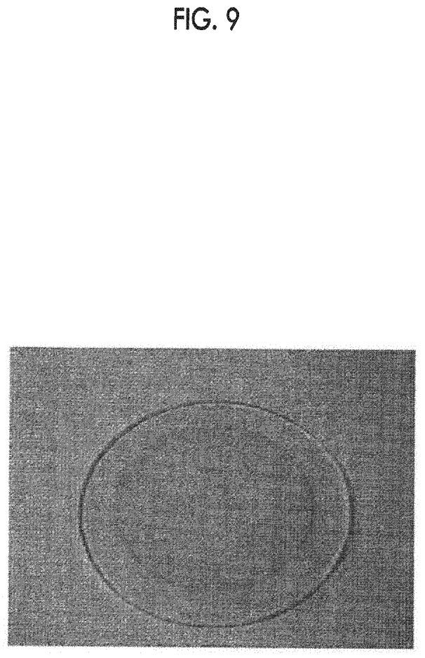

The third comparative example will be described with reference to FIGS. 8 and 9, and Table 1. The third comparative example is the experimental result when the workpiece W is welded by using the laser welding device 401 having the configuration different from that of the laser welding device 301 of the second comparative example.

As illustrated in FIG. 8, a volume of an internal space 403d of a chamber 403 is larger than a volume of an internal space 5a of a tubular portion 5. A length L1 of the chamber 3 in the irradiation direction E is longer than a length L2 of the tubular portion 5 in the irradiation direction E. Exhaust ports 412 and 413 are disposed in the second side wall portion 32 and the fourth side wall portion 34, respectively. Further, in a space 460a of a second tubular portion 460, the tapered nozzle 270 protrudes from an end portion 53a of a first tubular portion 450 on the irradiation direction E side.

In the third comparative example, the workpiece W (torque converter 100) was welded by the laser welding device 401 under the following conditions. A volume of the internal space 403d of the chamber 403 is 12 [L]. A volume of the internal space 405a of the tubular portion 405 is 4 [L]. A pressure in the internal space 403d of the chamber 403 is 0.1 [kPa]. The output of the laser beam irradiation unit 202 is 4.0 [kW]. The focal length F of the laser beam irradiation unit 202 is 250 [mm]. An inert gas is nitrogen. Diameters of the plurality of exhaust ports 412 and 413 are 50 [mm], respectively.

FIG. 9 illustrates a state of the laser transmission window 20 after the workpiece W is welded once by the laser beam irradiation unit 202 in the third comparative example. As illustrated in Table 1, from the experimental result of the third comparative example, the dirt adhering to the laser transmission window 20 is reduced as compared with the case of the second comparative example. However, it can be seen that the metal vapor is not effectively diffused in the tubular portion 405 because the length L2 of the tubular portion 405 of the irradiation direction E is not sufficiently secured. In addition, although the number of exhaust ports increased, it can be seen that the metal vapor was not sufficiently exhausted. Further, it can be seen that the tapered nozzle 270 protrudes into the space 460a of the second tubular portion 460, and thus, it is not possible to prevent the metal vapor adhering to the laser transmission window 20.

### Fourth Comparative Example

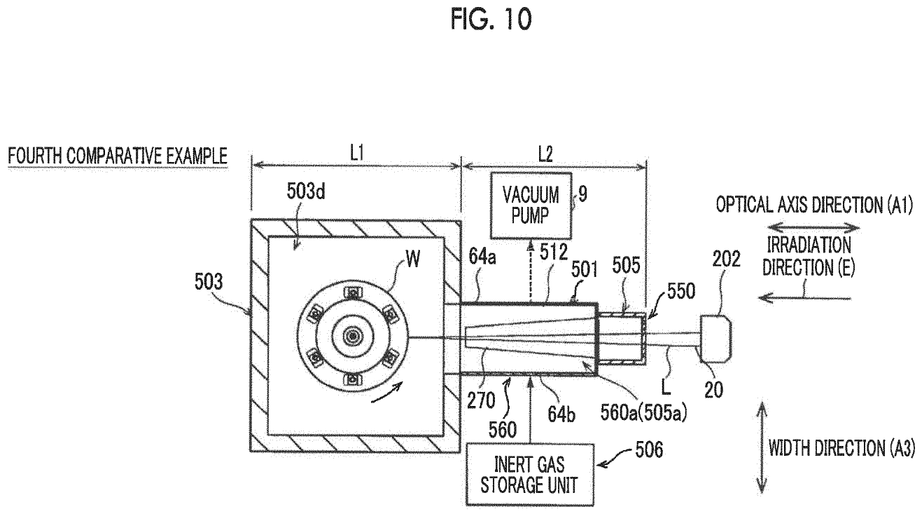

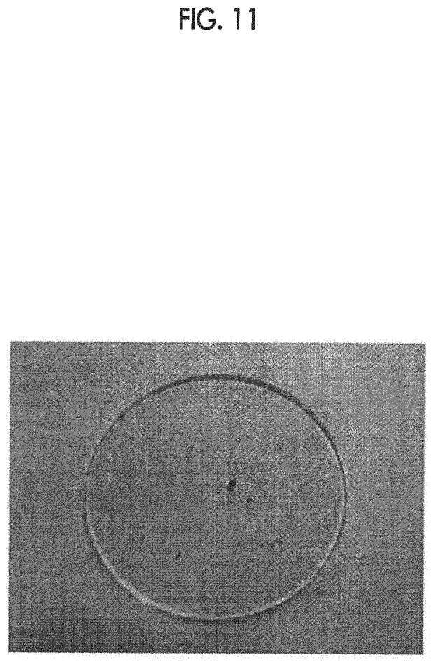

The fourth comparative example will be described with reference to FIGS. 10 and 11, and Table 1. The fourth comparative example is the experimental result when the workpiece W is welded by using the laser welding device 501 having the configuration different from that of the laser welding device 201 of the first comparative example.

As illustrated in FIG. 10, a volume of an internal space 503d of a chamber 503 is larger than a volume of an internal space 505a of a tubular portion 505. A length L1 of the chamber 503 in the irradiation direction E is longer than a length L2 of the tubular portion 505 in the irradiation direction E. An exhaust port 512 is disposed on a first side surface portion 64a of the second tubular portion 560. An inert gas supply unit 506 supplies an inert gas from a second side surface portion 64b of the second tubular portion 60. Further, in a space 560a of the second tubular portion 560, a tapered nozzle 270 protrudes from an end portion of the first tubular portion 550 on the irradiation direction E side.

In the fourth comparative example, the workpiece W (torque converter 100) was welded by the laser welding device 501 under the following conditions. A volume of the internal space 503d of the chamber 503 is 12 [L]. A volume of the internal space 505a of the tubular portion 505 is 4 [L]. A pressure in the internal space 503d of the chamber 503 is 0.1 [kPa]. The output of the laser beam irradiation unit 202 is 4.0 [kW]. The focal length F of the laser beam irradiation unit 202 is 250 [mm]. An inert gas is nitrogen. Diameters of the plurality of exhaust ports 512 (not illustrated) are 25 [mm], respectively.

FIG. 11 illustrates a state of the laser transmission window 20 after the workpiece W is welded once by the laser beam irradiation unit 202 in the fourth comparative example. As illustrated in Table 1, from the experimental result of the fourth comparative example, the dirt adhering to the laser transmission window 20 is reduced as compared with the case of the first comparative example. However, it can be seen that the metal vapor is not effectively diffused in the tubular portion 505 because the length L2 of the tubular portion 505 in the irradiation direction E is not sufficiently secured. Further, it can be seen that sputtering (metal melted by the laser beam L at the processing point P) adheres to the laser transmission window 20. It is considered that this is because a position of the exhaust port 512 and a supply position of the inert gas were changed, and the flow of the inert gas was changed, and thus, the sputtering increased. Further, it can be seen that a tapered nozzle 270 protrudes into the space 560a of the second tubular portion 560, and thus, it is not possible to suppress the adhesion of the metal vapor and the adhesion of the sputtering to the laser transmission window 20.

### Fifth Comparative Example

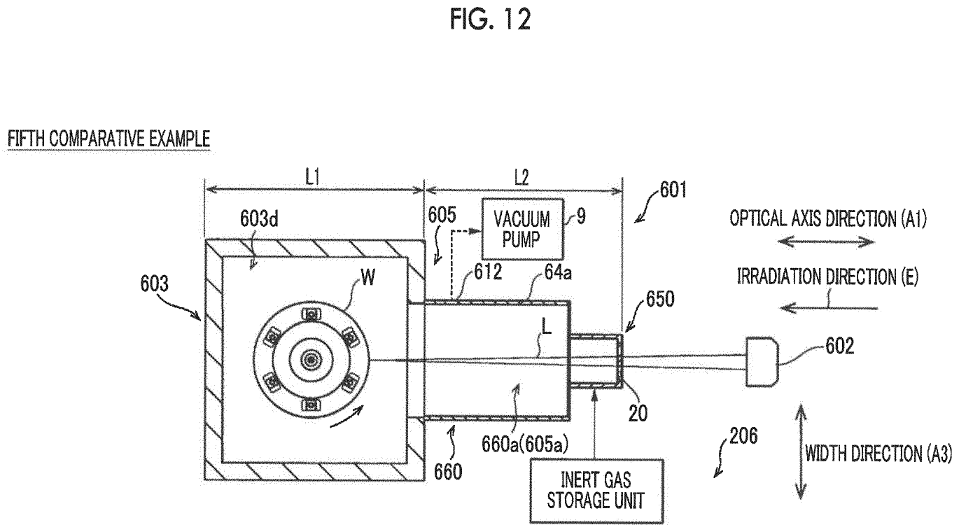

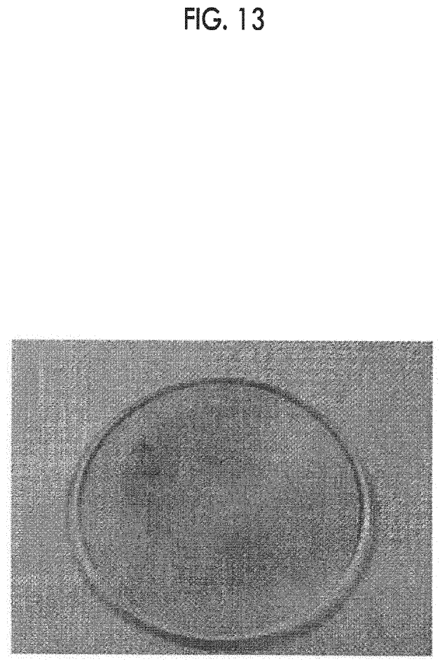

The fifth comparative example will be described with reference to FIGS. 12 and 13, and Table 1. The fifth comparative example is the experimental result when the workpiece W is welded by using the laser welding device 601 having the configuration different from that of the laser welding device 201 of the first comparative example.

As illustrated in FIG. 12, a volume of an internal space 603d of a chamber 603 is larger than a volume of an internal space 605a of a tubular portion 605. A length L1 of the chamber 603 in the irradiation direction E is longer than a length L2 of the tubular portion 5 in the irradiation direction E. An exhaust port 612 is disposed on a first side surface portion 64a of a second tubular portion 660.

In the fifth comparative example, the workpiece W (torque converter 100) was welded by the laser welding device 601 under the following conditions. A volume of the internal space 603d of the chamber 603 is 12 [L]. A volume of the internal space 605a of the tubular portion 605 is 8 [L]. A pressure in the internal space 603d of the chamber 603 is 0.1 [kPa]. An output of a laser beam irradiation unit 602 is 4.0 [kW]. A focal length F of the laser beam irradiation unit 602 is 450 [mm]. An inert gas is nitrogen. A diameter of the exhaust port 612 is 25 [mm].

FIG. 13 illustrates a state of the laser transmission window 20 after welding the workpiece W by the laser beam irradiation unit 602 five times in the fifth comparative example. As illustrated in Table 1, it can be seen from the experimental result of the fifth comparative example that the amount of metal vapor adhering to the laser transmission window 20 could be significantly reduced as compared with the experimental result of the first comparative example. However, it can be seen that the metal vapor is not sufficiently diffused in the tubular portion 605 because the length L2 of the tubular portion 605 in the irradiation direction E is not sufficiently secured.

### Second Embodiment

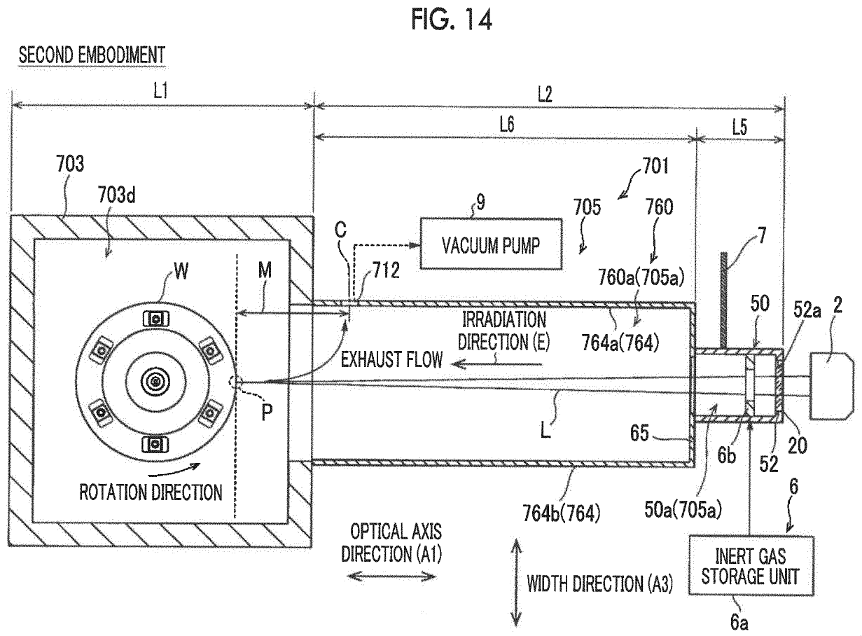

Next, a configuration of a laser welding device 701 according to a second embodiment of the present invention will be described with reference to FIG. 14. In the laser welding device 701 of the second embodiment, unlike the laser welding device 1 of the first embodiment, an exhaust port 712 is disposed in a second tubular portion 760, a length L1 of a chamber 703 in the irradiation direction E is reduced, and a length L6 of the second tubular portion 760 in the irradiation direction E increases. The same components as those of the laser welding device 1 of the first embodiment are designated by the same reference numerals, and repeated descriptions thereof will be omitted. Further, lengths L3, L4, and L7 of the chamber 703, the first tubular portion 50, and the second tubular portion 760 in the width direction A3 are the same as those in the first embodiment.

(Second Tubular Portion)

As illustrated in FIG. 14, the length L6 of the second tubular portion 760 in the irradiation direction E is longer than the length L1 of the chamber 703 in the irradiation direction E. As a result, a volume of a space 760a of the second tubular portion 760 is larger than a volume of an internal space 703d of the chamber 703.

(Exhaust Port)

The exhaust port 712 is connected to the vacuum pump 9 and is disposed in the second tubular portion 760 to be separated at a predetermined distance M from the end portion (processing point P) of the workpiece W on the side opposite to the irradiation direction E side to the side opposite to the irradiation direction E side. Further, the exhaust port 712 is provided on a side surface portion on a rotation direction side at the processing point P of the workpiece W. That is, since the rotation direction of the workpiece W is counterclockwise, the exhaust port 712 is formed on the first side surface portion 764a of the second tubular portion 760. Since the other configurations of the second embodiment are the same as those of the first embodiment, descriptions thereof will be omitted.

(Effect of Second Embodiment)

In the second embodiment, the following effects can be obtained.

In the second embodiment, as described above, by disposing the exhaust port 712 in the second tubular portion 760, it is possible to prevent the inert gas from flowing into the vicinity of the processing point P of the workpiece W as compared with a case where the exhaust port 712 is disposed in the chamber 703. As a result, the degree of vacuum at the processing point P can be stabilized, and thus, the quality of the welded portion of the workpiece W can be improved. Since the other effects of the second embodiment are the same as those of the first embodiment, descriptions thereof will be omitted.

### Modification Example

It should be noted that the above-described embodiments are exemplary in all respects and are not considered to be restrictive. A scope of the present invention is illustrated by claims rather than the descriptions of the above-described embodiments, and further includes all modifications (modification examples) within the meaning and scope equivalent to the claims.

For example, in the first and second embodiments, the workpiece W is a torque converter 100, but the present invention is not limited to this. In the present invention, the workpiece may be a mechanical component other than the torque converter.

Further, in the first and second embodiments, the laser beam irradiation unit 2 is illustrated an example of having a long focal length (focal length F: about 900 [mm]), but the present invention is not limited to this. In the present invention, the laser beam irradiation unit may have a focal length exceeding about 900 [mm].

Further, in the first embodiment, the size of the second tubular portion 60 is smaller than the size of the chamber 3, but the present invention is not limited to this. In the present invention, the size of the second tubular portion may be larger than the size of the chamber.

Further, in the first embodiment, the exhaust port is formed in the third side wall portion 33 of the chamber 3, but the present invention is not limited to this. In the present invention, the exhaust port may be formed in the upper wall portion, the lower wall portion, and the fourth side wall portion corresponding to the rotation direction of the workpiece.

### Reference Signs List

1: laser welding device

2: laser beam irradiation unit

3,703: chamber

3d, 703d: internal space

5,705: tubular portion

9: vacuum pump (pump)

10: support portion

12, 712: exhaust port

20: laser transmission window

33: third side wall portion (side surface portion)

50: first tubular portion

53a: end portion

60: second tubular portion

60a: space

62: upper surface portion

764a: first side surface portion (side surface portion)

A2: up-down direction (second direction)

A3: width direction (first direction)

E: Irradiation direction

H, L1, L2, L3, L4, L7: length

L: laser beam

M: predetermined distance

P: processing point

R: rotation axis

W: workpiece

1. A laser welding device comprising:
a chamber that has a low-pressure internal space in which a workpiece is disposed;
a laser beam irradiation unit that irradiates the workpiece with a laser beam to weld the workpiece; and
a tubular portion through which the laser beam from the laser beam irradiation unit passes and which communicates with the chamber,
wherein the tubular portion includes a first tubular portion that is disposed on a side opposite to an irradiation direction side of the laser beam and has a laser transmission window through which the laser beam is transmitted and a second tubular portion which has a space through which the laser beam passes and is adjacent to the irradiation direction side of the first tubular portion,
the second tubular portion has a constant cross-sectional shape orthogonal to the irradiation direction along the irradiation direction, and
the tubular portion has a predetermined length longer than a length of the chamber in the irradiation direction.

2. The laser welding device according to claim 1,
wherein an end portion of the first tubular portion on the irradiation direction side does not protrude into the space of the second tubular portion and is adjacent to an end portion of the second tubular portion on a side opposite to the irradiation direction side.

3. The laser welding device according to claim 1,
wherein the cross-sectional shape of the second tubular portion orthogonal to the irradiation direction is a rectangular shape.

4. The laser welding device according to claim 3,
wherein the second tubular portion has an upper surface portion extending in the irradiation direction in a plan view, and
the rectangular cross-sectional shape of the second tubular portion has a flat shape in which a length in a first direction orthogonal to the irradiation direction in an in-plane direction of the upper surface portion is longer than a length in a second direction orthogonal to the irradiation direction and the first direction.

5. The laser welding device according to claim 4,
wherein the length of the second tubular portion in the first direction is longer than half a length of the chamber in the first direction.

6. The laser welding device according to claim 4 or 5,
wherein a length of the first tubular portion in the first direction is shorter than the length of the second tubular portion in the first direction.

7. The laser welding device according to claim 6,
wherein a cross-sectional shape of the first tubular portion orthogonal to the irradiation direction has a circular shape.

8. The laser welding device according to claim 4, further comprising:
a pump which exhausts air in the chamber to form a low pressure in the internal space of the chamber,
wherein the chamber or the second tubular portion includes an exhaust port that is connected to the pump and is disposed at a predetermined distance from an end portion of the workpiece opposite to the irradiation direction side to the side opposite to the irradiation direction side.

9. The laser welding device according to claim 8, further comprising:
a support portion that rotatably supports the workpiece around a rotation axis along the second direction,
wherein the exhaust port is provided on a side surface portion of the chamber or the second tubular portion on a rotation direction side at a processing point where the laser beam from the laser beam irradiation unit is applied to the workpiece.
